(19) United States
(12) Patent Application Publication
(10) Pub. No.: US 2026/0040093 A1
(43) Pub. Date: Feb. 5, 2026

(54) COOPERATIVE USER DETECTION IN NON-TERRESTRIAL NETWORKS

(71) Applicant: InterDigital Patent Holdings, Inc., Wilmington, DE (US)

(72) Inventors: Dylan Watts, Montreal (CA); Brian Martin, Farnham (GB); Umer Salim, Vallauris (FR)

(73) Assignee: InterDigital Patent Holdings, Inc., Wilmington, DE (US)

(21) Appl. No.: 18/794,962

(22) Filed: Aug. 5, 2024

(51) Int. Cl. H04W 24/02; H04L 5/00; H04W 74/0833; H04W 84/06

(52) U.S. Cl. CPC H04W 24/02; H04L 5/0051; H04W 74/0833; H04W 84/06

(57) ABSTRACT

Systems, methods, and instrumentalities are described herein related to cooperative user detection in non-terrestrial networks. For example, a wireless transmit/receive unit (WTRU) may be provided for cooperative user detection. A configuration may be received. The configuration may comprise configuration information associated with cooperative user detection in a non-terrestrial network. The configuration information may indicate a detection duration value and a reference signal. A notification may be received. The notification may indicate that the WTRU is to monitor the reference signal. A duration timer may be started. The duration of the duration timer may be set to the detection duration value. A measurement of the reference signal may be determined before the expiration of the duration timer. It may be determined that the WTRU is a cooperative user on a condition that the measurement exceeds a threshold.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein related to cooperative user detection in non-terrestrial networks. For example, a wireless transmit/receive unit (WTRU) may be provided for cooperative user detection. A configuration may be received. The configuration may comprise configuration information associated with cooperative user detection in a non-terrestrial network. The configuration information may indicate a detection duration value and a reference signal. A notification may be received. The notification may indicate that the WTRU is to monitor the reference signal. A duration timer may be started. For example, the duration timer may be started on a condition that the notification was received. The duration of the duration timer may be set to the detection duration value. A measurement of the reference signal may be determined before the expiration of the duration timer. It may be determined that the WTRU is a cooperative user on a condition that the measurement exceeds a threshold. The determination that the WTRU is a cooperative user may trigger the WTRU to send a preamble. The preamble may be sent to a network node before the expiration of the duration timer on a condition that it is determined that the WTRU is the cooperative user. The preamble may indicate that the WTRU is a cooperative user.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of an integration of a notification/alert channel and a cooperative user into the paging framework according to an embodiment.

FIG. 3 illustrates an example of detecting cooperative user based on satisfaction of a threshold criteria according to an embodiment.

FIG. 4 illustrates an example of detection of a non-cooperative user based on expiry of a detection timer according to an embodiment.

### EXAMPLE NETWORKS FOR IMPLEMENTATION OF THE EMBODIMENTS

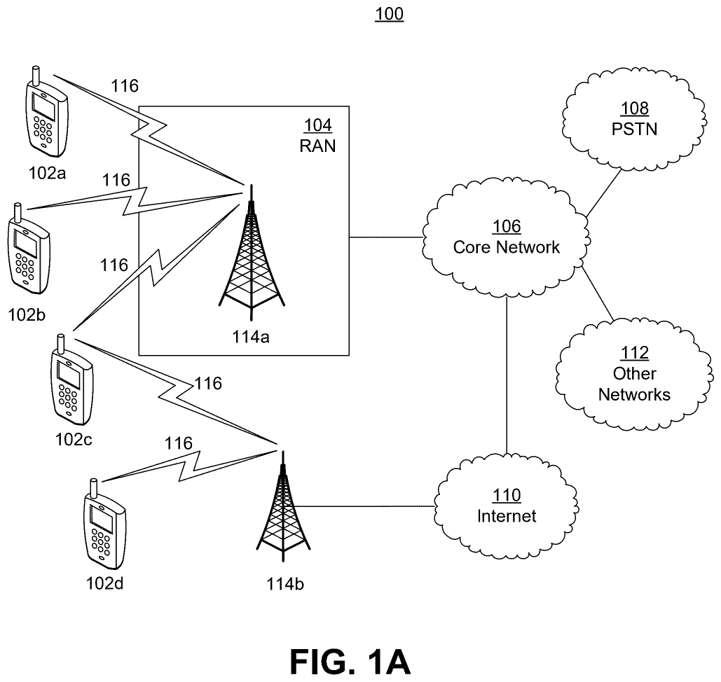

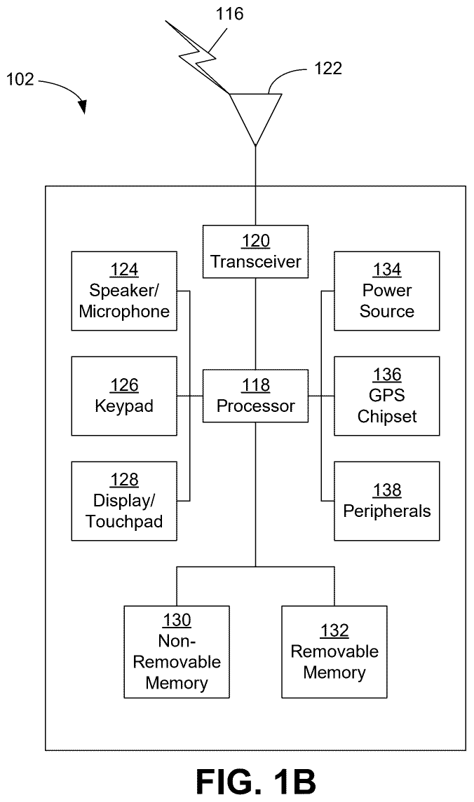

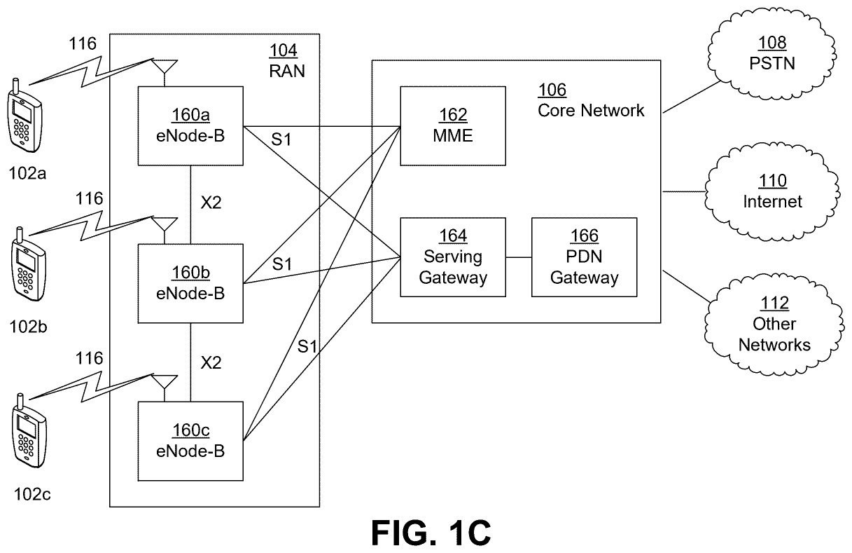

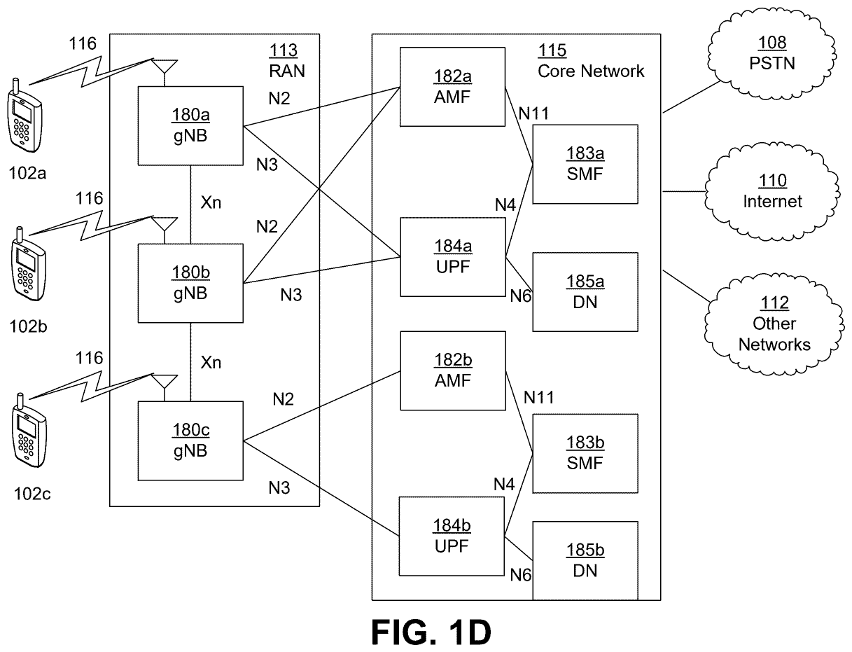

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHz, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

Reference to a timer herein may refer to a time, a time period, tracking the time, tracking the period of time, etc. Reference to a timer expiration herein may refer to determining that the time may have occurred or that the period of time may have expired.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Systems, methods, and instrumentalities are described herein related to cooperative user detection in non-terrestrial networks. For example, a wireless transmit/receive unit (WTRU) may be provided for cooperative user detection. A configuration may be received. The configuration may comprise configuration information associated with cooperative user detection in a non-terrestrial network. The configuration information may indicate a detection duration value and a reference signal. A notification may be received. The notification may indicate that the WTRU is to monitor the reference signal. A duration timer may be started. For example, the duration timer may be started on a condition that the notification was received. The duration of the duration timer may be set to the detection duration value. A measurement of the reference signal may be determined before the expiration of the duration timer. It may be determined that the WTRU is a cooperative user on a condition that the measurement exceeds a threshold. The determination that the WTRU is a cooperative user may trigger the WTRU to send a preamble. The preamble may be sent to a network node before the expiration of the duration timer on a condition that it is determined that the WTRU is the cooperative user. The preamble may indicate that the WTRU is a cooperative user.

In an example, the configuration may be a first configuration. A second configuration may be applied on a condition that it is determined that the WTRU is the cooperative user. The first configuration may be released on a condition that the second configuration is applied.

In an example, the configuration may be a first configuration. A connection may be established to the network node. A second configuration may be applied on a condition that it is determined that the WTRU is a cooperative user. The first configuration may be released on a condition that the connection is established.

In an example, the configuration information may indicate at least one of a measurement threshold, a reference signal, a detection duration threshold, a detection time, or a detection duration.

In an example, the reference signal may be received during the detection duration.

In an example, the reference signal may be received before the expiration of the duration timer.

In an example, determining that the WTRU is a cooperative user may comprise a number of operations or actions. For example, the reference signal may be monitored upon receiving the notification. It may be determined that the WTRU is a cooperative user on a condition that the reference signal is detected before the expiration of the duration and the measurement exceeds a threshold.

In an example, determining that the WTRU is the cooperative may comprise a number of operations or actions. For example, the reference signal may be monitored upon receiving the notification. It may be determined that the WTRU is the cooperative user on a condition the reference signal is detected before an expiration of the duration timer.

In an example, determining that the WTRU is the cooperative user may comprise a number of operations or actions. For example, a measurement of the reference signal may be determined before an expiration of the duration timer. It may be determined that the WTRU is the cooperative user on a condition that the measurement exceeds a threshold.

In an example, the measurement may be at least one of a signal strength, a Reference Signal Received Power (RSRP), a pathloss, a power level, or a delay value.

In an example, a message or a preamble may be associated with at least one of a Random Access Channel (RACH) message, a preamble message, or a Physical Random Access Channel (PRACH) message.

Systems, methods, and instrumentalities are described herein related to cooperative user detection in non-terrestrial networks. A wireless transmit/receive unit (WTRU) may use a configuration for cooperative user detection. A WTRU may receive a configuration to detect whether a user is cooperative. The configuration may include one or more of the following: a set of reference signals to measure user cooperation, an evaluation period, evaluation criteria, and/or triggers to start and/or terminate the cooperative user detection. The WTRU may acquire/update a configuration, for example, based on the measurements of one or more reference signals and/or NTN deployment characteristics. The WTRU may release the cooperative user detection configuration, for example, upon connection establishment or a determination that a user is non-cooperative.

A WTRU may make a cooperative user determination. A WTRU may determine the evaluation period for cooperative user detection and measurement based on downlink (DL) reference signals (RSs) dedicated for cooperative user detection, one or more other RSs, or a combination thereof (e.g., based on configuration). The WTRU may determine whether a user is cooperative, for example, based on criteria, such as the number of measurements within a time period exceeding a threshold or detection of an RS. The WTRU may evaluate the cooperative user detection criteria over an (e.g., one) RS, one time period, or multiple time periods. If multiple time periods are used for evaluation, the WTRU may compare measurements across time periods to evaluate criteria. The WTRU may determine that a user is “non-cooperative,” for example, if the cooperative user detection criteria are not satisfied, or if a separate set of criteria (e.g., a non-cooperative user detection criteria) are satisfied.

WTRU behavior may be based on a cooperative user detection. Upon cooperative user detection, a WTRU may switch from monitoring a DL notification channel to a paging channel (e.g., to receive subsequent DL signaling). The WTRU may notify the network of a successful cooperative user detection, for example, via initiating a random access channel (RACH) using a (e.g., dedicated) preamble, a radio network identifier (RNTI), RACH occasions, etc. The WTRU, having declared a user non-cooperative, may terminate the cooperative detection procedure, log any received DL signaling, and re-attempt cooperative user detection or channel access, for example, after a backoff period.

A Non-Terrestrial Networks (NTN) may include an aerial or space-borne platform which, via a gateway (GW), may transport signals from a land-based gNB to a WTRU, and vice-versa. Aerial or space-borne platforms may be classified in terms of orbit. Non-geosynchronous orbit (NGSO) satellites may include low-earth orbit (LEO) satellites (e.g., with an altitude range of 300-1500 km), and medium-earth orbit (MEO) satellites (e.g., with an altitude range of 7000-25000 km). NGSO satellites may move continuously overhead relative to Earth. Geosynchronous orbit (GSO) satellites may remain fixed overhead (e.g., by maintaining an altitude of 35,786 km).

Satellite platforms may be (e.g., further) classified as having a transparent or regenerative payload. Transparent satellite payloads may implement frequency conversion and RF amplification in uplink and downlink. Multiple transparent satellites may be connected to one land-based gNB. Regenerative satellite payloads may implement a full gNB or a gNB DU onboard the satellite. Regenerative payloads may perform digital processing on the signal. The processing may include demodulation, decoding, re-encoding, re-modulation, and/or filtering.

An NTN satellite may support multiple cells. A cell (e.g., each cell) may include one or more satellite beams. Satellite beams may cover a footprint on Earth (e.g., like a terrestrial cell). Satellite beams may range in diameter, for example, from 100-1000 km in NGSO deployments, and 200-3500 km diameter in GSO deployments. Beam footprints (e.g., the area covered by a beam/cell) in GSO deployments may remain fixed relative to Earth. Beam footprints in NGSO deployments may change over time, for example, due to satellite movement. Beam movement may be classified as earth moving, for example, where an NGSO beam may move continuously across the earth, or earth fixed, where the beam may be steered to remain covering a fixed location until a new cell overtakes the coverage area in a discrete and coordinated change.

Non-terrestrial networks may be associated with one or more of the following operational aspects: 1) continuous movement of NGSO satellites overhead, which may result in frequent and continuous TA drift; 2) cell sizes up to 3500 km in diameter; and 3) round trip times (RTT) several orders of magnitude larger than terrestrial networks (e.g., up to 541.46 ms).

DL coverage may be enhanced in non-terrestrial networks, for example, to accommodate satellite payload constraints. A satellite may be unable to have all its beams active with the (e.g., nominal) equivalent isotropically radiated power (EIRP) density per beam at a given time, for example, due to limited power and/or limited feeder link bandwidth. The number of beams that are be activated simultaneously may be maximized. An objective may be to maximize the number of user terminals that can be served across the satellite foot print while maximizing the overall satellite throughput. An objective may be to ensure that the (e.g., all of the) satellite's radio cells are kept alive (e.g., even without traffic), while allowing new users to join and preventing impact on end-user QoS. For example, the link level may be managed to improve the link margin of selected physical channels to accommodate an EIRP reduction, for example, in FR1-NTN. A link margin improvement for physical channels (e.g., physical downlink shared channel (PDSCH) and physical downlink control channel (PDCCH) may be implemented, for example, without impacting the synchronization signal block (SSB) (e.g., apart from extended periodicity). For example, a system level may be managed to support an efficient dynamic and flexible power sharing between beams or different beam pattern/size (e.g., wide or narrow) across the satellite foot print, for example, for FR1-NTN and FR2-NTN.

A DL notification/alert and/or cooperative user detection may be utilized for some DL coverage limited WTRUs. NTN DL coverage may be enhanced to improve line-of-sight (LOS) WTRUs experiencing poor DL coverage due to EIRP density reduction caused by satellite power sharing. Non-line-of-sight (NLOS) WTRUs (e.g., approximately 10% of rural WTRUs) may experience clutter loss, which may result in coverage drops, for example, of 18 dB. The reduction may severely impact the ability for some NLOS WTRUs to receive DL signaling, such as paging.

In NTN, some user actions (e.g., taking a phone outside of a briefcase or moving outdoors) may improve the coverage conditions of a WTRU, which may be referred to as user cooperation. A request for user cooperation may be prompted (e.g., indicated, signaled). To prompt such cooperation, a notification/alert may be sent to a WTRU, for example, through a heavily coverage-enhanced channel, which may result in channel conditions being improved sufficiently (e.g., through user actions/cooperation) to receive paging via traditional paging channels. Reaching DL coverage limited WTRUs may be important, for example, to convey emergency signaling and alerts to WTRUs that may not have an alternative form of connection.

Integration of a notification/alert channel for NTN into a (e.g., general) paging framework may be supported/accomplished, for example, based on one or more of the following aspects: identification of revised satellite parameters that may be used to represent the power sharing case, for example, to be used for simulation and/or determination of channels/revised target link margin; a notification channel to receive paging in coverage limited scenarios; and/or a cooperative user concept.

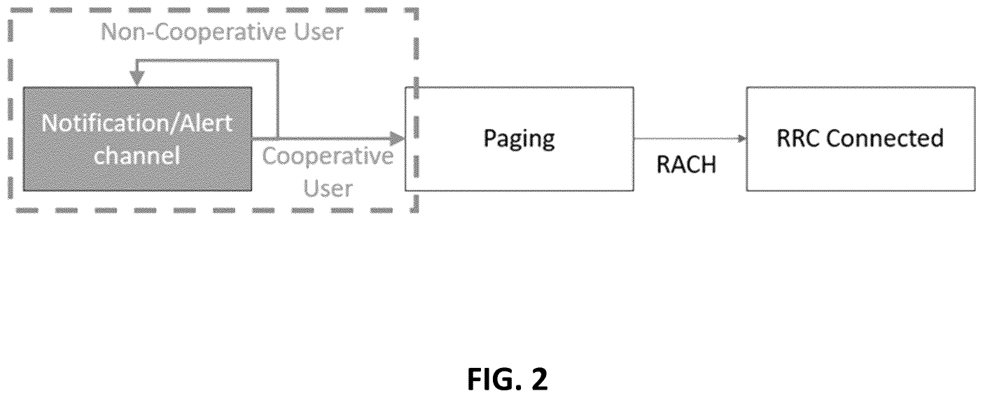

FIG. 2 illustrates an example of integration of a Notification/Alert channel and a cooperative user into the paging framework according to an embodiment.

As described herein, there may be a system-level impact of integrating a co-operative user concept into one or more procedures.

A notification channel may be implemented. Without a notification channel, if the current radio conditions of a cell are poor, a WTRU may attempt to search for a suitable neighboring cell. The WTRU may broaden the search criteria. The WTRU may continuously monitor for a suitable cell until one is found, which may result in excessive monitoring/power consumption.

A cooperative user concept may be integrated into one or more procedures, such as a (e.g., general) paging framework, to improve DL coverage in NTN networks for heavily coverage limited WTRUs.

As described herein, a WTRU may receive a configuration to determine whether a user is cooperative. A configuration may include, for example, one or more of the following: 1) a measurement-based threshold, 2) one or more DL reference signals, and/or 3) a detection time period/timer duration. The WTRU (e.g., upon reception of a notification) may start a detection time period. The WTRU may monitor the configured DL reference signal. The WTRU may be considered cooperative, for example, if the measurements of the reference signal (e.g., meet or) exceed the configured measurement threshold within the time period. The WTRU may trigger a RACH with a resume cause notification reception.

A WTRU may perform one or more actions/operations. For example, a WTRU may receive a configuration to determine whether a WTRU is cooperative. The configuration may include, for example, one or more of the following: one or more conditions (e.g., reference signal received power (RSRP)-based) to determine whether the WTRU is a cooperative user (e.g., RSRP Thresholds T1); one or more reference signals to evaluate DL coverage; and/or a timer to monitor the channel, for example, until the WTRU is declared un-cooperative (e.g., a cooperative user detection timer). The WTRU may monitor a notification channel. The WTRU may receive a notification on the notification channel. The WTRU may start a cooperative user detection timer. The WTRU (e.g., while the cooperative user detection timer is running) may monitor RSRP/DL pathloss conditions for a cooperative user determination, for example, using reference signals provided in the notification channel configuration. The WTRU may be considered a cooperative user, for example, if RSRP (or DL pathloss)>T1. The WTRU (e.g., determined to be cooperative) may perform RACH. The WTRU may switch to monitoring for DL paging. The WTRU may indicate (e.g., via dedicated preamble, MSG3/MSG5/MSGA, or resume cause) that the WTRU is accessing the cell after a received notification.

Cooperative user detection in NTNs may provide one or more benefits/advantages. For example, cooperative user detection may enable the WTRU to determine when the WTRU can transition back to other (e.g., legacy) channels and/or resume operation on other (e.g., legacy) channels. A WTRU may be provided with a reasonable chance of success if/when attempting to receive paging and/or to perform RACH, which may reduce signaling overhead, for example, from wasted paging escalation, and/or WTRU transmission power, for example, due to failed RACH attempts.

In some examples, a WTRU may determine whether a WTRU has sufficiently improved DL coverage to allow the WTRU to, for example, switch from monitoring a notification/alert channel to a paging channel, receive further DL information, and/or access a cell.

In some scenarios (e.g., in non-terrestrial networks) where DL coverage may be extremely limited, user cooperation may be utilized to improve the DL coverage to receive further information (e.g., paging) and/or for cell access. A user may be described as cooperative, for example, if the DL coverage has been improved via WTRU actions, for example, by leaving a building, taking a WTRU out of a pocket or bag, moving to a clear space, etc. Procedures are defined herein to support detection of user cooperation and associated WTRU actions.

A WTRU may support one or more (e.g., a combination) of the actions/operations described herein. Terminology, principles/observations, benefits, and examples are described herein.

A notification/alert channel may refer to a channel (e.g., meant or configured to be) used in downlink coverage-limited areas where, for example, a WTRU may not be able to receive paging or detect SSB, for example, via normal operation. The terms “notification channel,” “notification/alert channel,” and “alert channel” may be used interchangeably herein.

A notification/alert may refer to a message received (e.g., or alternatively transmitted) by the WTRU over a notification channel. For example, a notification/alert may be used to notify the user that coverage under current conditions is too poor to receive/transmit data over legacy channels, and/or to prompt the user to improve channel conditions, for example, via user action. The terms “notification,” “notification/alert,” and “alert” may be used interchangeably herein.

A cooperative user may be a WTRU in a poor coverage condition that has improved coverage conditions sufficiently to resume and/or have a likelihood of successfully performing (e.g., legacy) operations (e.g., paging and/or RACH). Coverage conditions may have improved, for example, due to user actions (e.g., taking a phone out of a bag), for example, in response to reception of a notification/alert.

A non-cooperative user may be a WTRU in a poor coverage condition that has not improved coverage conditions sufficiently to resume and/or have a likelihood of successfully performing (e.g., legacy) operations (e.g., paging and/or RACH).

The terms cooperative user detection and cooperative user determination may be used interchangeably herein to describe WTRU actions and/or procedures to determine whether a user is cooperative (e.g., DL coverage has improved).

Examples described herein highlight a use case of a non-terrestrial network. However, examples described herein may (e.g., also) apply to other networks (e.g., terrestrial, aerial, etc.).

A notification channel may refer to any type of channel (e.g., new or existing, PDCCH-based or sequence based, repetition-based, etc.) that may be used to support coverage limited WTRUs.

A notification/alert channel may be downlink only, support both uplink and downlink, or may have different channels to support uplink and downlink.

A notification/alert may refer to a specific message, or any message received by the WTRU over a notification/alert channel.

A notification may (e.g., also) be received over a legacy channel. A notification may be distinguished from other (e.g., legacy) messages.

Terms such as channel quality or cell quality may (e.g., be intended to) describe a metric that may be used to evaluate the strength of the radio quality of a WTRU connection. Quality metrics may be based on L1 measurements (e.g., SSB/CSI-RS), filtered L3 measurements (e.g., RSRP/RSRQ), and/or any other measurement or cell quality metric.

Support of a notification/alert channel may improve WTRU operation, for example, within heavily coverage limited scenarios. Examples described herein may offer, for example, one or more of the following benefits: improved WTRU-NW synchronization, which may maximize the chance that the WTRU may remain reachable at times of poor coverage; reduced WTRU signaling overhead, for example, due to excessive repeated RACH failure; reduced network signaling overhead, for example, due to a lowered probability of paging escalation; and/or increased WTRU power saving, for example, by avoiding unnecessary monitoring of a paging channel that signaling may not or may be unlikely to successfully be received.

A WTRU may use a configuration for cooperative user detection. A WTRU may provide or be provided with information and/or configurations to support cooperative user detection in a (e.g., non-terrestrial) network. Configurations for cooperative user detection may be (e.g., specific to) a serving cell and/or satellite or may (e.g., alternatively) be provided for one or more neighboring cell(s)/satellite(s). Configuration(s) of one or more components of a configuration for cooperative user determination may be common to multiple (e.g., many) WTRUs (e.g., provided via broadcast signaling), dedicated, or group specific. Configuration(s) of one or more components of a configuration for cooperative user determination may apply currently or may apply at a time or time period in the future. Information (e.g., described herein) may be indicated explicitly (e.g., via system information (SI)), provided via one or more configuration(s) (e.g., a cooperative user configuration), and/or may be interpreted implicitly (e.g., via other information, such as satellite assistance information within ntnConfig).

Examples described herein may support the exchange of (e.g., required/relevant) information between the WTRU and network to support cooperative user detection, which may ensure that information is acquired/available if/when needed and may remain valid/up to date.

In some examples, a WTRU may be configured for cooperative user detection. Configurations to support cooperative user detection may include, for example, configurations to support the measurement, evaluation, and/or reporting of the results of cooperative user detection.

A WTRU may use a configuration of reference signal(s) for cooperative user detection. In some examples, a WTRU may be configured with one or more reference signals to support WTRU determination of whether a user is cooperative. The reference signal(s) may be valid for a specific cell, satellite, and/or satellite beam, and/or the reference signal(s) may be valid for multiple (e.g., two or more) cell(s), satellite(s), and/or satellite beam(s).

The reference signal(s) may be, for example, a synchronization signal block (SSB), channel state information-reference signal (CSI-RS), demodulation reference signal (DM-RS), and/or a (e.g., dedicated) reference signal that may be specific to cooperative user detection. The reference signal(s) may be transmitted once, within a time period, and/or periodically.

A reference signal may have an (e.g., explicit) indication that the reference signal may be used for cooperative user detection. A WTRU may be configured (e.g., via a flag) to use the configured reference signals for cooperative user detection. A WTRU may use or combine other reference signals to evaluate whether the WTRU is a cooperative user.

A WTRU may use a configuration of a cooperative user detection time period. In some examples, a WTRU may be configured with a time-period to perform cooperative user detection. The configuration for the time period to perform cooperative user detection may include, for example, one or more of the following: an indication (e.g., flag) that no time period for cooperative user detection applies; an indication (e.g., flag) that a time period for cooperative user detection applies; an offset to start cooperative user detection (e.g., the WTRU may wait a time period after the cooperative user detection procedure was triggered until the WTRU may start monitoring); a start time for cooperative user detection; an end time for cooperative user detection; a duration for cooperative user detection; and/or a periodicity where the WTRU may perform cooperative user detection (e.g., a reference time; a period to start the monitoring; and/or an offset time to start the on duration).

A WTRU may use a configuration of conditions to determine cooperative user status. In some examples, a WTRU may be configured with one or more conditions and/or criteria to determine whether a user is cooperative. A configuration for the cooperative user detection condition(s)/criteria may include, for example, one or more of the following: one or more thresholds; a number of measurements X that may be compared to (e.g., above) a threshold; a number of measurements Y that may be compared to (e.g., below) a threshold; an indication that condition(s) may be satisfied over multiple (e.g., more than one) monitoring periods; a number of monitoring periods that condition(s) may be satisfied to be declared cooperative; and/or an indication that multiple (e.g., more than one) monitoring periods may be compared.

A WTRU may use a configuration for a non-cooperative user. In some examples, a WTRU may receive a configuration for a non-cooperative user. A non-cooperative user configuration may be applied, for example, if/when a cooperative user detection has failed. A non-cooperative user configuration may support, for example, methods to determine when a WTRU is non-cooperative and/or configurations to control WTRU actions upon detection that the WTRU is non-cooperative. The configuration for a non-cooperative user may include, for example, one or more of the following: one or more thresholds; an indication (e.g., a flag) whether the WTRU may re-attempt cooperative user detection; and/or a time period (e.g., a backoff time) until the WTRU may re-attempt cooperative user detection.

A WTRU may use a configuration to trigger cooperative user detection. In some examples, a WTRU may be configured with conditions to trigger cooperative user detection. The configuration to trigger cooperative user detection may include, for example, one or more of the following: one or more triggering condition(s)/criteria to initiate cooperative user detection (e.g., as described herein); and/or the number of times cooperative user detection may be triggered.

A WTRU may use a configuration to terminate cooperative user detection. In some examples, a WTRU may be configured with conditions to terminate cooperative user detection. A configuration for a time period to perform cooperative user detection may include, for example, one or more of the following: one or more conditions/criteria to terminate cooperative user detection (e.g., as described herein); a time period for the WTRU to complete cooperative user detection; and/or an indication whether a WTRU may re-attempt cooperative user detection.

A WTRU may use a configuration for channel access after notification channel alert. In some examples, a WTRU may be configured to access a cell after cooperative user detection. A configuration for cell access may include, for example, one or more of the following: a (e.g., dedicated) RACH configuration for channel access (e.g., dedicated RNTI, RACH preamble, RACH occasion(s)); an indication whether the WTRU may indicate the WTRU is accessing the channel after cooperative user detection; one or more (e.g., pieces of) assistance information to notify the network (e.g., as described herein); an indication how the WTRU may signal the information (e.g., within a RACH message, via RRC, and/or after connection setup).

In some examples, a WTRU may receive an indication/configuration that the WTRU may access the channel after cooperative user detection.

A WTRU may report additional assistance information, for example, after cooperative user detection.

Cooperative user detection signaling and configuration management may be performed. In some examples, methods to (re) acquire configurations for cooperative user detection may be used, for example, to ensure that a WTRU has (e.g., all required) information to determine if/when the WTRU may transition to a traditional paging channel, and/or to ensure that the information is valid/up to date.

A WTRU may receive and/or transmit signaling for a cooperative user detection configuration. In some examples, a WTRU may be provided with a cooperative user detection configuration upon release to RRC IDLE (e.g., within the RRC Release message) or upon release to RRC INACTIVE state (e.g., within the RRC Release with suspend message). In some examples, configurations for cooperative user detection may be indicated/configured/provided, for example, via one or more of the following signaling methods: SIB (e.g., within satellite assistance information (e.g., SIB 19, SIB31/32, a new SI block, or within another existing SIB), NAS, MAC CE, DCI, RACH (e.g., MSG2, MSG4, MSGB), RRC, and/or PDCCH/PUSCH.

In some examples, a WTRU may receive different components of a cooperative user detection configuration via multiple/different signaling methods. For example, a WTRU may receive (e.g., dedicated) configuration aspects via RRC signaling, and may receive other configurations or information via system information. A WTRU may be provided with a (e.g., dedicated) configuration for cooperative user detection. The WTRU may override other assistance information (e.g., received via broadcast signaling) or may combine the configuration with the (e.g., one or more pieces of) assistance information. In some examples, the WTRU may use the most recently received information.

A WTRU may be involved with handling a cooperative user detection configuration. In some examples, a WTRU may receive a configuration based on a network (NW) decision (e.g., upon release to RRC IDLE or RRC INACTIVE). In some examples, a WTRU may request to be configured with a cooperative user configuration. A WTRU may request a cooperative user configuration, for example, based on one or more of the following: one or more DL reference signals may have fallen below a threshold; the distance between the WTRU and a reference signal may be above a threshold; and/or the WTRU may enter a period of discontinuous coverage.

A WTRU (e.g., based on configuration of cooperative user detection) may monitor for one or more trigger conditions to perform user detection (e.g., as described herein). A WTRU may release the configuration, for example, upon one or more of the following circumstances: upon connection establishment; upon a failure to perform cooperative user detection (e.g., the user is non-cooperative); upon X successive failures; and/or expiry of an associated validity condition (e.g., after a time period).

In some examples, a WTRU may release (e.g., only specific) parts of a configuration. For example, upon declaring that a user is cooperative, the WTRU may release configurations related to a non-cooperative user.

Upon release of a cooperative user detection configuration, the WTRU may apply a second configuration (e.g., a default configuration). This configuration may be used, after connection establishment, (e.g., upon reception of an RRC configuration) or prior to connection to the cell. The second configuration (e.g., default configuration) may consist of, for example, different measurement resources (e.g., fewer RSs) and/or measurement periodicities (e.g., wider periodicity and/or offset value).

A WTRU may participate in a cooperative user determination. A notification may prompt a user to sufficiently improve conditions to enable communication, for example, via one or more (e.g., legacy) channels (e.g., paging, RACH). The WTRU may have one or more ways of determining when coverage has sufficiently improved, and/or what actions to perform when the WTRU is considered cooperative (e.g., monitor for paging, perform RACH, etc.). The determinations may be done in a power efficient manner, for example, to account for the WTRU potentially being un-cooperative for a time.

Examples described herein may support detection and declaration that a user is cooperative, for example, including measurement for cooperative user detection and declaration that a user is cooperative. Examples are also described herein to declare when a user is non-cooperative.

A WTRU may perform measurements for (non) cooperative user detection. In some examples, a WTRU may receive (e.g., as part of a cooperative user detection configuration) a configuration to perform measurements, for example, for the purpose of cooperative user detection. Configurations may include, for example, measurement periods and/or dedicated reference signal(s) for cooperative user detection.

A WTRU may select an RS to perform cooperative user detection. In some examples, a WTRU may be provided with a reference signal configuration for cooperative user detection. The WTRU may use (e.g., only) the reference signal(s) configured for cooperative user detection to evaluate whether the user may be cooperative.

A WTRU may be provided/configured with reference signal(s) for cooperative user detection that may have expired (e.g., the time period the reference signal(s) are available has completed). The WTRU may use one or more other detected reference signal(s) or may terminate the cooperative user detection procedure, for example, if there are no valid reference signals for cooperative user detection. Whether the WTRU continues the procedure or terminates the procedure may depend on, for example, whether the WTRU may detect an alternative reference signal and/or whether the cooperative user detection configuration enables the use of other reference signal(s).

A WTRU may use any reference signal (e.g., an SSB-RS) for cooperative user detection, for example, if the WTRU is not provided/configured with additional (e.g., valid) reference signal(s) for cooperative user detection.

There may be an evaluation period for cooperative user detection. In some examples, a WTRU may monitor (e.g., indefinitely) to determine when/if a user is declared a cooperative user. A WTRU may determine it may continuously monitor, for example, based on a (e.g., an explicit) configuration, or by lack of a configuration, which may limit the monitoring duration.

In some examples, a WTRU may be provided with one or more DL RS(s) to monitor for user cooperation. The WTRU may (e.g., implicitly) determine the timer period when the WTRU may monitor for user cooperation, for example, based on the pattern and time the DL RS(s) may be received. In some examples, the DL RS(s) may be associated with a duration. The WTRU may evaluate for cooperative user detection during the time period associated with the DL RS(s).

In some examples, a WTRU may be configured with a time period to perform cooperative user detection. For example, the WTRU may be provided with a start time and/or end time. The WTRU may monitor for cooperative user detection during the time period associated with a start and/or end time. In some examples, the WTRU may be provided with a start time and duration. The WTRU may start monitoring at the indicated time. The WTRU may monitor for the indicated duration. In some examples, the WTRU may be provided with a duration. The WTRU may start the duration (e.g., a time period), for example, upon triggering a cooperative user detection procedure (e.g., as described herein). In some examples, the time period may be maintained in the WTRU via a cooperative user detection timer. The WTRU may start the timer upon triggering cooperative user detection. The WTRU may monitor for cooperative user detection while the timer is running.

In some examples, a WTRU may be configured to monitor for cooperative user detection periodically. For example, a WTRU may be provided with one or more of: a reference time, offset, on duration, and/or periodicity. The WTRU may start monitoring for cooperative user detection after an offset from a reference time (e.g., universal time coordinated (UTC) time, system frame number (SFN), slot). The WTRU may monitor for cooperative user detection while in the on duration. The WTRU may monitor again for successive on durations based on the configured periodicity.

A WTRU may start evaluating immediately (e.g., once the procedure is triggered) or after an offset from when the procedure is triggered.

A WTRU may perform cooperative user detection. In some examples, one or more methods may be used to determine when a user is cooperative, for example, to ensure that DL coverage has sufficiently increased to, for example, transition to a DL paging channel and/or access a cell. Examples are described herein to trigger, determine, and terminate cooperative user detection.

A WTRU may perform one or more methods for cooperative user detection. In some examples, a WTRU may determine a user is cooperative based on satisfaction of one or more conditions. A user may be declared cooperative, for example, if one or more configured conditions are satisfied. The WTRU may determine whether a user is cooperative, for example, if one or more of the following criteria are satisfied: an RS is detected; the WTRU can decode SI; a measurement is above a threshold; X measurements are above a threshold; X successive measurements are above a threshold; the average of X measurements are above a threshold; a measurement is not below a threshold; fewer than Y measurements are below a threshold; fewer than Y successive measurements are below a threshold; the average of Y measurements are not below a threshold.

In some examples, one or more conditions may be satisfied within a time period (e.g., a window) for the user to be declared cooperative. In some examples, the conditions may be satisfied in multiple (e.g., more than one) measurement windows for the WTRU to be declared as a cooperative user. In some examples, the WTRU may declare that the user is cooperative if one or more conditions are satisfied at any time. In some examples, the WTRU may compare measurements from different evaluation periods. The WTRU may determine whether a user is cooperative, for example, if one or more of the following criteria are satisfied: the difference between a measurement in time period A and time period B is above a threshold; the difference between X measurements in time period A and time period B is above a threshold; and/or the difference between the average measurements in time period A and time period B is above a threshold.

One or more triggers may be used to start cooperative user detection. In some examples, a WTRU may trigger cooperative user detection. The WTRU may trigger cooperative user detection, for example, based on (e.g., upon the occurrence of) one or more of the following: reception of a notification alert; start of a cooperative user detection evaluation window or period; expiry of a time period (e.g., after a backoff time); failure to establish and/or resume a connection; detection of a new cell; detection of a new satellite; detection of an RS; reception of a cooperative user detection configuration; modification of a cooperative user detection configuration; and/or the WTRU location is determined to be less than a distance threshold from a reference point.

One or more triggers may be used to terminate cooperative user detection. In some examples, a WTRU may terminate cooperative user detection. The WTRU may terminate cooperative user detection, for example, based on (e.g., upon the occurrence of) one or more of the following: detection/determination that a user is cooperative; detection/determination that a user is non-cooperative; connection to a network; detection of an RS; successful decoding of SSB; successful reception of a DL transmission; and/or expiry of a time period.

A WTRU may perform non-cooperative user detection. In some examples, methods to determine when a user is non-cooperative may be used, for example, to ensure that a WTRU does not prematurely transition to a DL paging channel (e.g., prior to sufficient improvement in DL coverage). Examples are described herein to determine when a user is non-cooperative.

A WTRU may make a declaration of a non-cooperative User. In some examples, a WTRU may declare that a use is non-cooperative (e.g., the WTRU may be unable to sufficiently improve the DL coverage conditions to be declared cooperative). The WTRU may be declared non-cooperative, for example, based on (e.g., upon the occurrence of) one or more of the following: the WTRU failed a cooperative user detection attempt (e.g., the configured condition(s) for cooperative user detection were not satisfied); the WTRU failed X cooperative user detection attempts (e.g., the configured condition(s) for cooperative user detection were not satisfied after X attempts); the WTRU was not determined to be cooperative within a time period; a measurement is below a threshold; X measurements are below a threshold; X successive measurements are below a threshold; the average of X measurements is below a threshold; the difference between a measurement in time period A and time period B is below a threshold; the difference between X measurements in time period A and time period B is below a threshold; and/or the difference between the average measurements in time period A and time period B is below a threshold.

WTRU behavior may be indicated based on (e.g., after) cooperative user detection. One or more methods may be used to transition a WTRU (e.g., back) to a state of normal operation based on (e.g., upon) a detection that DL coverage has sufficiently improved (e.g., to support reception of DL paging or to access the cell) via user cooperation. Coordination (e.g., additional coordination) between the WTRU and network may be defined to ensure that the WTRU and network are aware of how and where the WTRU may be reached.

Examples described herein describe WTRU behavior (e.g., actions, transmissions, and monitoring) after detection of user cooperation. Examples are also described to support WTRU operation when a user has been identified as non-cooperative.

WTRU behavior(s) may be triggered based on (e.g., after) cooperative user detection. In some examples, a WTRU may perform one or more WTRU actions based on (e.g., upon) detection that DL coverage has sufficiently improved due to user cooperation. For example, the WTRU may modify how the WTRU monitors for DL signaling and/or may notify the network that the WTRU may no longer (e.g., need to) monitor the notification/alert channel.

A WTRU may monitor for subsequent DL signaling after a cooperative user detection. In some examples, after the WTRU has sufficiently improved DL coverage (e.g., via user cooperation), the WTRU may monitor for subsequent DL signaling (e.g., paging). A WTRU may, for example, upon cooperative user detection, stop monitoring the notification/alert channel and/or may (e.g., instead) monitor for paging. The WTRU may revert back to monitoring the notification/alert channel, for example, based on (e.g., upon the occurrence of) one or more of the following: if the WTRU does not receive paging information within a time period; and/or if the DL coverage degrades (e.g., again).

A WTRU, for example, after cooperative user detection, may monitor for paging directly after the detection or may send a prior notification to the network before switching to the notification channel. WTRU behavior may depend upon, for example, a NW configuration.

WTRU notification may be provided after a cooperative user detection. In some examples, upon detection that a user is cooperative, a WTRU may attempt to access a cell. The WTRU may, for example, perform RACH. The WTRU may access the cell using a (e.g., dedicated) RACH configuration (e.g., if a configuration is provided within the cooperative user detection configuration), for example, via one or more of the following: a dedicated RNTI; a dedicated RACH occasion(s); and/or a dedicated preamble.

A WTRU may notify the network that the WTRU is accessing the cell after successful cooperative user detection. The notification may include, for example, an indication that the WTRU is monitoring the DL paging channel.

A WTRU may transmit the notification, for example, via one or more of the following signaling methods: RACH (e.g., MSG1, preamble, MSGA, MSG3), RRC, MAC CE, UCI, PDSCH/PUCCH, or NAS signaling. The signaling chosen by the WTRU may depend upon, for example, the type of information included within the notification.

A WTRU may provide additional information to the network. In some examples, a WTRU may provide additional information (e.g., regarding the notification message and/or the cooperative user detection period). The (e.g., additional) information may include, for example, an indication of how long the cooperative user detection took.

WTRU behavior may be indicated based on (e.g., after) failure to become a cooperative user. In some examples, DL coverage may not sufficiently improve to, for example, receive DL paging or to access a cell, for example, based on insufficient user actions. The user (e.g., WTRU) may be declared as non-cooperative. One or more procedures may be defined to indicate if/when the WTRU may re-attempt cooperative user detection, for example, to avoid excessive power consumption due to continual monitoring for cooperative user detection.

WTRU behavior may be based on a determination of a non-cooperative user. In some examples, a WTRU may perform one or more actions based on (e.g., upon, in response to) a determination that the WTRU is a non-cooperative user. A WTRU, for example, upon non-cooperative user detection, may, for example, perform one or more of the following actions: terminate the cooperative user detection procedure; release the cooperative user detection configuration; log information related to received DL signaling (e.g., an alert received on a notification channel), such as the time of the message reception and/or the contents of the notification message; trigger a cell search; and/or enter discontinuous reception (DRX).

In some examples, the WTRU may re-attempt cooperative user detection, for example, after a time period. In some examples, the WTRU may receive a backoff time. The backoff time may be an explicit time (e.g., 10:35:00 UTC). The WTRU may not attempt cooperative user detection until the indicated backoff time. In some examples, the WTRU may be provided with a prohibit timer duration. The WTRU may start the prohibit timer duration, for example, upon initiation of a cooperative user detection procedure or failure of a cooperative user detection procedure. The WTRU may not reattempt cooperative user detection, for example, while the timer is running.

In some examples, the WTRU may (e.g., directly) attempt to perform RACH after failure of the cooperative user detection. The WTRU may, for example, use a (e.g., dedicated) RACH configuration (e.g., dedicated preamble, RNTI, RACH occasions, RACH resources) associated with channel access after declaration of a user being non-cooperative. The WTRU may (e.g., directly) attempt RACH, for example, with maximum power ramping.

A WTRU may inform the network that the WTRU was previously declared as a non-cooperative user, for example, if the WTRU (e.g., eventually) accesses the cell (e.g., via successful completion of a RACH procedure). The WTRU may include additional assistance information to the network, for example, if the WTRU was performing the indication after having been previously considered un-cooperative. Additional assistance information may include, for example, one or more of the following: number of one or more missed notifications; time of one or more missed notifications; and/or contents of one or more missed notifications.

A WTRU may perform cooperative user detection. For example, a WTRU may receive a configuration to determine whether a user is cooperative. The configuration may include, for example, one or more of the following: a measurement-based threshold; one or more DL reference signals; and/or a detection time period/timer duration. A WTRU may start a detection time period and may monitor the configured DL reference signal(s), for example, based on (e.g., upon) reception of a notification.

The WTRU may be considered cooperative, for example, if the measurements of the reference signal (e.g., meet or) exceed the configured measurement threshold within the time period. The WTRU may trigger RACH, for example, with a resume cause notification reception.

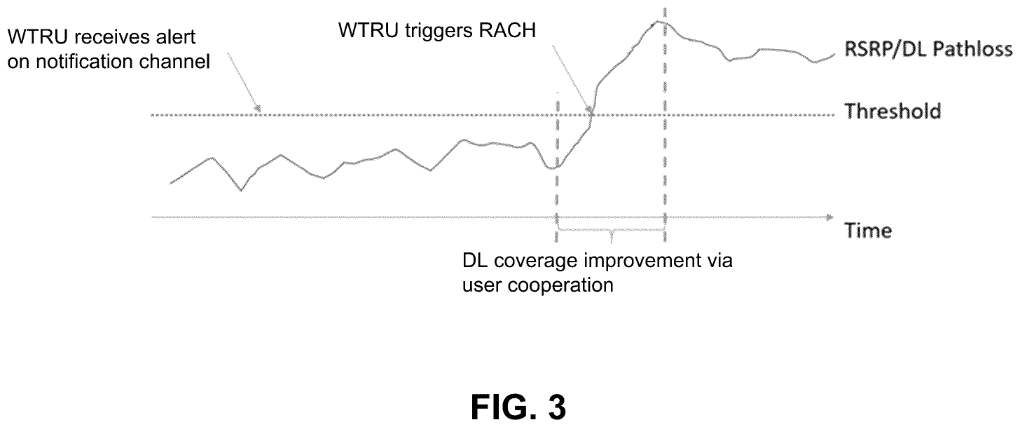

FIG. 3 illustrates an example of detection of a cooperative user based on satisfaction of a threshold criteria according to an embodiment.

For example, a WTRU may perform one or more of the following, for example, to support power sharing state pre-reporting. A WTRU may receive a configuration to determine whether a WTRU is cooperative. The configuration may include, for example, one or more of the following: one or more conditions (e.g., RSRP-based) to determine whether the WTRU is a cooperative user (e.g., RSRP Thresholds T1); one or more reference signals to evaluate DL coverage; and/or a timer to monitor the channel, for example, until WTRU may be declared un-cooperative (e.g., cooperative user detection timer). The WTRU may monitor a notification channel. The WTRU may receive a notification on the notification channel. The WTRU may start a cooperative user detection timer. The WTRU (e.g., while the cooperative user detection timer is running) may monitor RSRP/DL pathloss conditions for a cooperative user determination using reference signals provided in the notification channel configuration. The WTRU may be considered a cooperative user, for example, if RSRP (or DL pathloss)>T1. The WTRU may perform RACH. The WTRU may indicate (e.g., via dedicated preamble, MSG3/MSG5/MSGA, or resume cause) that the WTRU is accessing the cell after a received notification.

A WTRU may receive a configuration to determine a user is cooperative. The configuration may include, for example, one or more of the following: a measurement-based threshold; one or more DL reference signals; and/or a detection time period/timer duration. The WTRU may start a detection time period and may monitor the configured DL reference signal, for example, based on reception of a notification. The WTRU may be considered cooperative, for example, if the measurement(s) of the reference signal exceed the configured measurement threshold, for example, within the time period. The WTRU may trigger RACH, for example, with a (e.g., new) resume cause notification reception.

Cooperative user detection may provide one or more benefits/advantages. For example, cooperative user detection may enable the WTRU to determine when the WTRU can transition (e.g., back) to (e.g., legacy) channels and/or resume (e.g., legacy) operation. Cooperative user detection may ensure that the WTRU may have a reasonable chance of success when attempting to receive paging or perform RACH. Cooperative user detection may reduce signaling overhead, for example, by avoiding wasted paging escalation. Cooperative user detection may reduce WTRU transmission power, for example, by avoiding failed RACH attempts.

A WTRU may perform non-cooperative user detection. For example, a WTRU may receive a configuration to determine whether a user is cooperative. The configuration may include, for example, one or more of the following: a measurement-based threshold; one or more DL reference signals; and/or a detection time period/timer duration. The WTRU may start a detection time-period and may monitor the configured DL reference signal, for example, based on (e.g., upon) reception of a notification.

The WTRU may be considered a non-cooperative user, for example, if an RSRP (e.g., or DL pathloss) does not satisfy the conditions (e.g., threshold T1), for example, prior to cooperative user detection timer expiry. The WTRU may log the time (e.g., UTC time) of the reception of the notification and/or additional information, such as the contents of the notification message. The WTRU may continue to monitor RSRP until improving to become a cooperative user, for example, and then perform RACH. The WTRU may indicate assistance information associated with the missed notification, such as the number of missed notifications, time of missed notification(s), and/or contents of the missed notification(s).

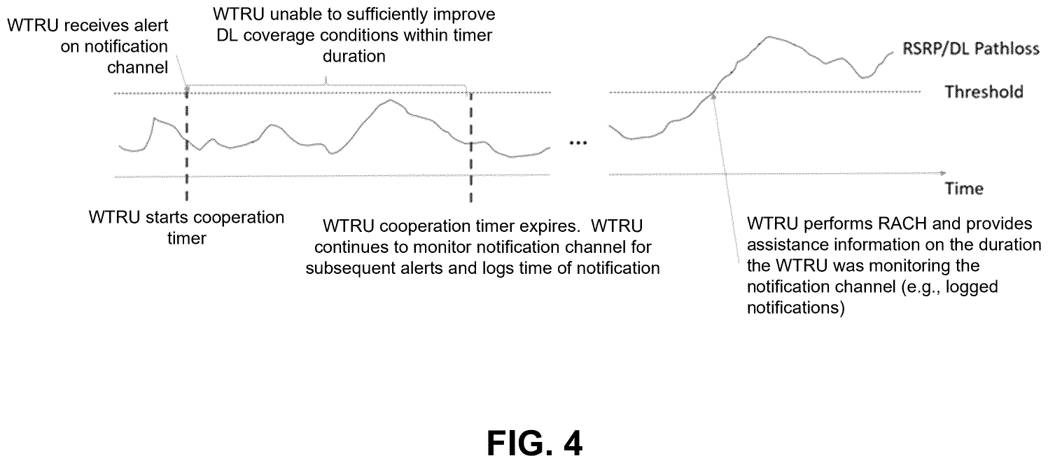

FIG. 4 illustrates an example of detection of a non-cooperative user based on expiry of a detection timer according to an embodiment.

For example, the WTRU may perform one or more of the following, for example, to support power sharing state pre-reporting. A WTRU may receive a configuration to determine whether a WTRU is cooperative. The configuration may include, for example, one or more of the following: one or more conditions (e.g., RSRP-based) to determine whether the WTRU is a cooperative user (e.g., RSRP Thresholds T1); one or more reference signals to evaluate DL coverage; and/or a timer to monitor the channel, for example, until the WTRU may be declared un-cooperative (e.g., cooperative user detection timer).

The WTRU may monitor a notification channel. The WTRU may receive a notification on the notification channel. The WTRU may start the cooperative user detection timer. The WTRU (e.g., while the cooperative user detection timer is running) may monitor RSRP/DL pathloss conditions for a cooperative user determination using reference signals provided in the cooperative user detection configuration. The cooperative user detection timer may expire after the configured duration. The WTRU is considered a non-cooperative user, for example, if an RSRP (e.g., or DL pathloss) does not satisfy the conditions (e.g., threshold T1) prior to the cooperative user detection timer expiry. The WTRU may log the time (e.g., UTC time) of the reception of the notification and/or additional information, such as the contents of the notification message. The WTRU may monitor RSRP/DL pathloss for a cooperative user determination. The WTRU may be considered a cooperative user, for example, if RSRP (or DL pathloss)>T1. The WTRU may perform RACH. The WTRU may indicate (e.g., via dedicated preamble, MSG3/MSG5/MSGA, or resume cause) that the WTRU is accessing the cell after a missed notification.

The WTRU may indicate assistance information associated with the missed notification, such as the number of missed notifications, the time(s) of the missed notification(s), and/or contents of the missed notification(s).

A WTRU may receive a configuration to determine whether a user is cooperative. The configuration may include, for example, one or more of the following: a measurement-based threshold; one or more DL reference signals; and/or a detection time period/timer duration. The WTRU (e.g., upon reception of a notification) may start a detection time period and may monitor the configured DL reference signal. The WTRU may be considered cooperative, for example, if the measurement(s) of the reference signal exceeds the configured measurement threshold, for example, within the time period. The WTRU may be considered uncooperative, for example, if the measurement(s) of the reference signal does not exceed the configured measurement threshold, for example, within the time period. The WTRU, for example, if determined to be cooperative, may trigger RACH, for example, with a new resume cause notification reception. The WTRU, for example, if determined to be uncooperative, may log information and/or make another attempt to be considered cooperative.

Non-cooperative user detection may provide one or more benefits/advantages. For example, non-cooperative user detection may enable the WTRU to determine whether it may transition back to (e.g., legacy) channels and/or resume (e.g., legacy) operation. Non-cooperative user detection may ensure that the WTRU may have a reasonable chance of success when attempting to receive paging or perform RACH. Non-cooperative user detection may reduce signaling overhead, for example, by avoiding wasted paging escalation. Non-cooperative user detection may reduce WTRU transmission power, for example, by avoiding failed RACH attempts.

Although features and elements described above are described in particular combinations, a feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU), the WTRU comprising:
a processor, wherein the processor is configured to:
receive a configuration, wherein the configuration comprises configuration information associated with cooperative user detection in a non-terrestrial network, and wherein the configuration information indicates a detection duration value and a reference signal;
receive a notification indicating the WTRU is to monitor the reference signal;
start a duration timer on a condition that the notification is received, wherein a duration of the duration timer is set to the detection duration value;
determine a measurement of the reference signal before an expiration of the duration timer;
determine that the WTRU is a cooperative user on a condition that the measurement exceeds a threshold, wherein the determination that the WTRU is the cooperative user triggers the WTRU to send a preamble; and
send the preamble to a network node before the expiration of the duration timer on a condition that it is determined that the WTRU is the cooperative user, wherein the preamble indicates that the WTRU is the cooperative user.

2. The WTRU of claim 1, wherein the configuration is a first configuration, and wherein the processor is further configured to:
apply a second configuration on a condition that it is determined that the WTRU is the cooperative user; and
release the first configuration on a condition that the second configuration is applied.

3. The WTRU of claim 1, wherein the configuration is a first configuration, and wherein the processor is further configured to:
establish a connection to the network node;
apply a second configuration on a condition that is determined that the WTRU is the cooperative user; and
release the first configuration on a condition that the connection is established.

4. The WTRU of claim 1, wherein the configuration information further indicates at least one of a measurement threshold, a detection duration threshold, or a detection time.

5. The WTRU of claim 1, wherein the processor is further configured to receive the reference signal before the expiration of the duration timer.

6. The WTRU of claim 1, wherein the processor being configured to determine that the WTRU is the cooperative user comprises the processor being configured to:
monitor the reference signal upon receiving the notification; and
determine that the WTRU is the cooperative user on a condition the reference signal is detected before the expiration of the duration timer and the measurement exceeds the threshold.

7. The WTRU of claim 1, wherein the measurement is at least one of a signal strength, a Reference Signal Received Power (RSRP), a pathloss, a power level, or a delay value.

8. The WTRU of claim 1, wherein the preamble is associated with at least one of a Random Access channel (RACH) message, a preamble message, or a Physical Random Access Channel (PRACH) message.

9. A method performed by a wireless transmit/receive unit (WTRU), the method comprising:
receiving a configuration, wherein the configuration comprises configuration information associated with cooperative user detection in a non-terrestrial network, and wherein the configuration information indicates a detection duration value and a reference signal;
receiving a notification indicating the WTRU is to monitor the reference signal;
starting a duration timer on a condition that the notification is received, wherein the duration of the duration timer is set to the detection duration value;
determining a measurement of the reference signal before an expiration of the duration timer;
determining that the WTRU is a cooperative user on a condition that the measurement exceeds a threshold, wherein the determination that the WTRU is the cooperative user triggers the WTRU to send a preamble; and
sending the preamble to a network node before the expiration of the duration timer on a condition that it is determined that the WTRU is the cooperative user, wherein the preamble indicates that the WTRU is the cooperative user.

10. The method of claim 9, wherein the configuration is a first configuration, and wherein the method further comprises:
applying a second configuration on a condition that it is determined that the WTRU is the cooperative user; and
releasing the first configuration on a condition that the second configuration is applied.

11. The method of claim 9, wherein the configuration is a first configuration, and wherein the method further comprises:
establishing a connection to the network node;
applying a second configuration on a condition that is determined that the WTRU is the cooperative user; and
releasing the first configuration on a condition that the connection is established.

12. The method of claim 9, wherein the configuration information further indicates at least one of a measurement threshold, a detection duration threshold, or a detection time.

13. The method of claim 9, wherein the method further comprises receiving the reference signal before the expiration of the duration timer.

14. The method of claim 9, wherein determining that the WTRU is the cooperative user comprises:
monitoring the reference signal upon receiving the notification; and
determining that the WTRU is the cooperative user on a condition the reference signal is detected before the expiration of the duration timer and the measurement exceeds the threshold.

15. The WTRU of claim 9, wherein the measurement is at least one of a signal strength, a Reference Signal Received Power (RSRP), a pathloss, a power level, or a delay value.

16. The method of claim 9, wherein the preamble is associated with at least one of a Random Access channel (RACH) message, a preamble message, or a Physical Random Access Channel (PRACH) message.
